(19) United States
(12) Patent Application Publication
(10) Pub. No.: US 2023/0191899 A1
(43) Pub. Date: Jun. 22, 2023

(54) COOLING SYSTEM

(71) Applicant: MAHLE International GmbH, Stutttlgart (DE)

(72) Inventors: Richard Bruemmer, Stuttgart (DE); Gunther Hentschel, Uhingen (DE); Rainer Lutz, Steinheim (DE); Thomas Strauss, Notzingen (DE)

(21) Appl. No.: 18/084,553

(22) Filed: Dec. 20, 2022

(30) Foreign Application Priority Data
Dec. 20, 2021 (DE) 10 2021 214 728.3

(51) Int. Cl. B60K 11/04; B60K 1/00

(52) U.S. Cl. CPC B60K 11/04; B60K 1/00; B60K 2001/003

(57) ABSTRACT

A cooling system for a vehicle is disclosed. The cooling system includes a cooling circuit that is flowed through by a coolant. The cooling circuit includes a first heat source, a first radiator, a second heat source, and a second radiator. A first partial circuit is provided with the first heat source and the first radiator fluidically connected to one another. A second partial circuit is provided with the second heat source and the second radiator fluidically connected to one another. The first partial circuit and the second partial circuit can be hydraulically separated from one another at times such that the two partial circuits are flowed through by a part of the coolant, and hydraulically connected to one another at times such that the two partial circuits can be jointly flowed through by a common part of the coolant.

### CROSS REFERENCE TO RELATED APPLICATION

This application claims priority to German Application No. DE 10 2021 214 728.3 filed on Dec. 20, 2021, the contents of which are hereby incorporated by reference in its entirety.

### TECHNICAL FIELD

The invention relates to a cooling system for a vehicle, in particular for a utility vehicle. The invention also relates to a method for operating the cooling system.

### BACKGROUND

A cooling system for a vehicle always has to provide an adequate cooling capacity for an energy source and a braking system. Frequently, a fuel cell as energy source and a retarder for braking are employed in a vehicle. A retarder can be a continuous brake or a clutch and operate hydrodynamically or electrodynamically. More often, the retarder is employed in heavy utility vehicles - such as for example trucks or busses. More often, an adequate cooling capacity for the braking system cannot be provided in this case since the temperature of the coolant in the cooling system is predetermined by the maximum cooling temperature of the fuel cell. In order to avoid damaging the fuel cell, the temperature of the coolant in the cooling system always has to be kept below the maximum cooling temperature of the fuel cell. The maximum cooling temperature of the fuel cell is significantly below the possible cooling temperature of the brake of 90-105° C. The cooling capacity of the cooling system in the vehicle with the fuel cell compared with the vehicle with a conventional internal combustion engine is thus significantly reduced during the braking operation. In order to increase the cooling capacity of the cooling system, the cooling system – for example radiator and pumps – has to be enlarged. A cooling system enlarged in such a manner is cost-intensive and requires increased space in the vehicle.

The object of the invention therefore is to state for a cooling system of the generic type an improved or at least alternative embodiment with which the described disadvantages are overcome. The object of the invention also is to provide a corresponding method for operating the cooling system.

According to the invention, this object is solved through the subject of the independent claim(s). Advantageous embodiments are subject of the dependent claims.

### SUMMARY

The cooling system is provided for a vehicle, in particular for a utility vehicle. The cooling system comprises a cooling circuit that can be flowed through by a coolant. The cooling circuit comprises a first heat source to be cooled at a lower temperature level and a second heat source that can be cooled at a higher temperature level. In addition, the cooling circuit comprises a first radiator and a second radiator. According to the invention, the first heat source and the first radiator are fluidically connected to one another in a first partial circuit of the cooling circuit and the second heat source and the second radiator in a second partial circuit of the cooling circuit. The first partial circuit and the second partial circuit can be hydraulically separated from one another at times and completely or almost completely. Because of this, the two partial circuits can each be flowed through by a part of the coolant. In addition, the first partial circuit and the second partial circuit can be hydraulically connected to one another at times and completely or almost completely, so that the two partial circuits can be jointly flowed through by a common part of the coolant.

In the cooling system according to the invention, the first heat source and the second heat source can be cooled simultaneously via the first radiator and the second radiator respectively, without a significant mixing of the coolant flows of the two partial circuits occurring. Because of this, each of the heat sources can be cooled at its own temperature level. With sole operation of the first heat source, by contrast, the first heat source can be cooled via the two radiators. Then, the second pump is stationary and the second heat source is not flowed through, as a result of which a connection of both partial circuits is established and the two radiators are then connected in parallel.

In the cooling system according to the invention, the two partial circuits can be hydraulically separated from one another and hydraulically connected to one another and the cooling system can be operated at least in a braking mode and in a normal operating mode. In the braking mode – as described in more detail below – the first partial circuit and the second partial circuit can be hydraulically or fluidically separated from one another at times and completely or almost completely. Accordingly, coolant flows of the two partial circuits are not mixed or only slightly so. Because of this, the two partial circuits can each be flowed through by a part of the coolant, wherein the two parts of the coolant and thus the two heat sources can be cooled differently by the two radiators. In other words, the first heat source can then be cooled via the first radiator that can be flowed through by the first part of the coolant and the second heat source via the second radiator that can be flowed through by the second part of the coolant. Altogether, the first heat source and the second heat source can be cooled at the different temperature levels. Accordingly, the first heat source in the cooling system can be cooled at a lower temperature level than the second heat source and an overheating of the first heat source can thus be prevented. Accordingly, the second heat source can be cooled at a higher temperature level than the first heat source and the cooling capacity in the second partial circuit can thus be significantly increased. In addition, an evaporation cooling can be employed for cooling the second heat source and the cooling capacity in the second partial circuit further increased. In the normal operating mode – as described in more detail below – the first partial circuit and the second partial circuit can be hydraulically or fluidically connected to one another at times and completely or almost completely. Because of this, the two partial circuits can be jointly flowed through by a common part of the coolant and because of this the common part of the coolant can be cooled by the first radiator and/or by the second radiator. Because of this, the first heat source can simultaneously access the two radiators and thus be intensively cooled in the normal operating mode. In the normal operating mode, the two radiators can be connected in particular parallel to one another.

The terms “hydraulically separated almost completely” and “almost completely connected hydraulically” are used here in order to clarify that in the cooling system, leakage flows in one of the modes described above, cannot be excluded. Thus, a leakage flow can flow through the two partial circuits in the braking mode, as is provided in the normal operating mode. Similarly, leakage flows that are separated from one another in the normal operating mode can flow in the two partial circuits separately from one another, as is provided in the braking mode. However, the leakage flows are so low that the braking mode and the normal operating mode are only insignificantly influenced by these and remain distinguishable from one another.

Here, the first heat source can be in particular a fuel cell of the vehicle and the second heat source can be in particular a retarder of the vehicle. In order to increase the difference between the temperature levels, the first radiator, with respect to the airflow direction, can be connected upstream of the second radiator. Then, the two radiators can partially or completely overlap one another in the airflow direction. Here, the respective radiator can practically be a coolant-air-radiator. The coolant can be in particular a liquid. By connecting the first radiator upstream of the second radiator, the coolant, in the first partial circuit, can be more intensively or greatly cooled than in the second partial circuit because of a higher driving temperature gradient. In addition, the two radiators are connected in parallel in the cooling system, so that the pressure loss in the cooling circuit can be reduced. Because of this, more efficient or additional pumps in the cooling system can be omitted.

Altogether, a cooling capacity that is comparable with a cooling capacity in a conventional vehicle with an internal combustion engine can be achieved in the cooling system according to the invention in the braking mode. As a result, installation space, weight and costs can be saved and an optimal cost-benefit ratio with respect to the cooling capacity achieved.

Advantageously it can be provided that the cooling circuit comprises a first pump and a second pump. Then, the first pump is directly connected downstream or upstream of the first heat source in the first partial circuit and the second pump is directly connected downstream or upstream of the second heat source in the second partial circuit. The term “directly” in this context means that the respective pump and the respective heat source are connected to a common flow line between two adjacent branch nodes. Here, the first pump and the second pump can be regulated in such a manner that the two partial circuits can be hydraulically separated from one another completely or almost completely and can be hydraulically connected to one another or almost completely.

Here, the hydraulic separation can take place in particular in a braking mode - as described in more detail below. In the braking mode, the first heat source and the second heat source are cooled at the differing temperature levels. To this end, the pump pressure and mass flow of the coolant in the two pumps can be adjusted in such a manner that a mutual influencing between the partial circuits is avoided or at least minimised.

In a normal operating mode – as described in more detail below – only the first heat source is switched on and the second heat source is switched off. Accordingly, cooling of the second heat source is not necessary and the second pump can be switched off. In order to avoid a flow through the second heat source with the second pump switched off, a non-return valve can be directly connected downstream or upstream of the second heat source or a pump connected directly downstream or upstream of the second heat source. The term “directly” in this context means that the second heat source and the non-return valve are connected to a common flow line between two adjacent branch nodes. However, the non-return valve can prevent the flow through the second heat source and because of this pressure losses in the cooling circuit can be reduced.

The two pumps and flow lines leading to the pumps can be advantageously combined into a module. Alternatively, the two pumps can be realised by a double pump having a common shaft and a magnetic coupling for adjusting different rotational speeds differing. It is also conceivable that the two pumps are each realised by a pump with a viscous coupling – a so-called viscous pump – and can be operated with a common motor.

Advantageously, the cooling circuit can comprise an advance shut-off valve and a return shut-off valve. The advance shut-off valve and the return shut-off valve can be connected between the two partial circuits. The two partial circuits can be hydraulically separated from one another by the advance shut-off valve and the return shut-off valve. The advance shut-off valve and the return shut-off valve can, similar to the two pumps described above, separate the two partial circuits from one another in a braking mode – as described in more detail below – and connect these with one another in a normal operating mode – as described in more detail below.

Advantageously it can be provided that the first partial circuit comprises a warming-up bypass line connected in parallel with the first radiator for bypassing the first radiator and a warming-up bypass valve. The warming-up bypass line can be closed and opened by means of the warming-up bypass valve. Preferentially, the warming-up bypass valve can be a switching valve or a regulating valve or a thermostat valve. Here, the cooling system can then be operated in a warming-up mode – as described in more detail below. In the warming-up mode, the first radiator and the second partial circuit can be separated from the first heat source by the warming-up bypass valve and the warming-up bypass line be opened. Because of this, the coolant can bypass the first radiator and flow through the first heat source and the warming-up bypass line and because of this heat up or be heated up. In a braking mode or in a normal operating mode, the warming-up bypass line can be practically closed.

Alternatively or additionally it can be provided that the second partial circuit comprises a radiator bypass line connected in parallel with the second radiator for bypassing the second radiator and a radiator bypass valve. Here, the radiator bypass line can be closed and opened by means of the radiator bypass valve. By means of the radiator bypass valve, the mass flow of the coolant can be distributed between the second radiator and the radiator bypass line and because of this the cooling capacity of the second radiator can be adapted as required.

The invention also relates to a method for operating the cooling system described above. Here, the cooling system comprises a first pump directly connected upstream or downstream of the first heat source and a second pump directly connected upstream or downstream of the second heat source. The term “directly” in this context means that the respective pump and the respective heat source are connected to a common flow line between two adjacent branch nodes. As already explained above, the first heat source can be in particular a fuel cell and the second heat source in particular a retarder. The respective radiator can be in particular a coolant-air-radiator. The coolant can be in particular a liquid. Here, the cooling system can be operated in a braking mode, in a normal operating mode and in a warming-up mode.

In the braking mode, the first heat source and the second heat source are switched on and are cooled at the different temperature levels. Here, the first heat source can be in a no-load mode. In the braking mode, the first pump and the second pump are switched on and the first partial circuit and the second partial circuit – as already described above – are hydraulically separated from one another at times completely or almost completely. Because of this, the first partial circuit is flowed through by a first part of the coolant and the second cooling circuit by a second part of the coolant. By suitably adjusting the pump rotational speed(s) of the pumps connected in the two partial circuits, the degree of mixing of the coolant flows can be kept low and the temperature of the first part of the coolant in the first partial circuit be adjusted to a temperature that is lower than the temperature of the second part of the coolant in the second partial circuit. Because of this, the first heat source can be cooled at a lower temperature level and the second heat source at a higher temperature level. Because of this, on the one hand, overheating and damage to the first heat source can be prevented and, on the other hand, the cooling capacity on the second heat source increased.

In the normal operating mode, exclusively the first heat source is switched on and is cooled. By contrast, the second heat source is switched off and need not be cooled. In the normal operating mode, the first partial circuit and the second partial circuit are hydraulically connected to one another at times completely or almost completely. In addition, the first pump is switched on and the second pump switched off. The first partial circuit and at least in regions the second partial circuit are flowed through by a common part of the coolant. In the first partial circuit, the first heat source and the first radiator are flowed through. Since the two partial circuits are no longer hydraulically separated, the second partial circuit can also be flowed through completely or at least in regions. Accordingly, the flow through the second – deactivated – heat source can be prevented by means of a non-return valve directly connected downstream or upstream of the second heat source. The second radiator can also be flowed through or bypassed by way of a radiator bypass line connected in parallel with the second radiator. When the second radiator is flowed through, the first heat source can be cooled via the two radiators and because of this the temperature level of the first heat source be kept sufficiently low. By means of the radiator bypass line, the cooling capacity of the second radiator can be additionally adapted.

In the warming-up mode, the first heat source is switched on and the second heat source switched off. In addition, the first pump is switched on and the second pump switched off. Further, the second partial circuit and the first radiator are separated from the first heat source by means of a warming-up bypass valve and are not flowed through. Because of this, only the first heat source and a warming-up bypass line connected opposite in parallel with the heat source are flowed through in the warming-up mode. Preferentially, the warming-up bypass valve can be a switching valve or a regulating valve or a thermostat valve. Because of the reduced masses in the warming-up mode and the prevention of the flow through the two radiators, a more rapid heating of the coolant takes place. Because of this, the first heat source can rapidly reach the operating temperature.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 a circuit diagram of a cooling system according to the invention in a first embodiment;

FIG. 2 a circuit diagram of the cooling system according to the invention in a second embodiment.

### DETAILED DESCRIPTION

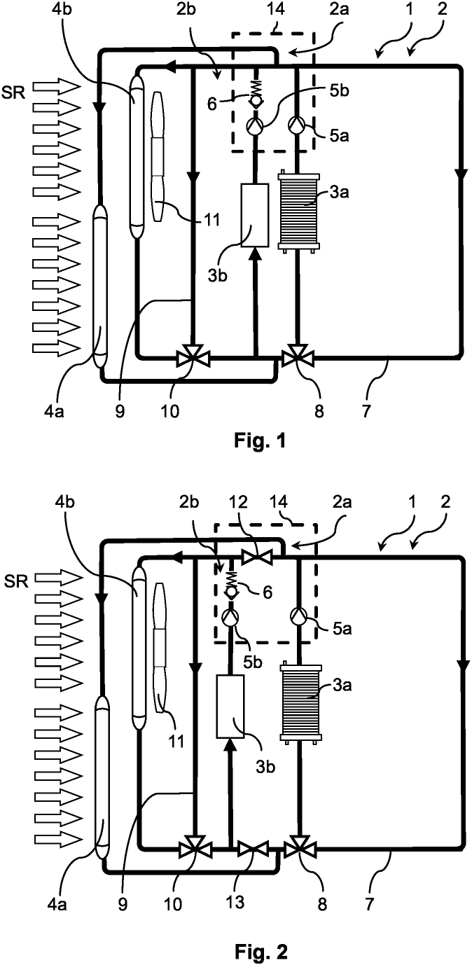

FIG. 1 shows a circuit diagram of a cooling system 1 according to the invention in a first embodiment. There, the cooling system 1 comprises a cooling circuit 2 with a first partial circuit 2a and with a second partial circuit 2b. In the first partial circuit 2a, a first heat source 3a and a first radiator 4a and in the second partial circuit 2b a second heat source 3b and a first radiator 4b are fluidically connected to one another. In addition, the first heat source 3a, the second heat source 3b, the first radiator 4a and the second radiator 4b are fluidically connected to one another in the cooling circuit 2. In other words, the two partial circuits 2a and 2b are fluidically connected to one another in the cooling circuit 2.

The cooling system 1 is provided for a vehicle, in particular for a utility vehicle. The first heat source 3a can be in particular a fuel cell and the second heat source 3b can be in particular a retarder or a brake resistor or another braking system. The first radiator 4a and the second radiator 4b are coolant-air radiators. The coolant is preferentially a liquid.

The cooling circuit 1 comprises a first pump 5a and a second pump 5b. The first pump 5a is directly connected in the first partial circuit 2a downstream of the first heat source 3a and the second pump 5b directly downstream of the second heat source 3b. However, it is also conceivable that the second pump 5b is directly connected upstream of the second heat source 3b. Further, a non-return valve 6 in the first partial circuit 2 is directly connected downstream of the first heat source 3a.

Further, the first partial circuit 2a comprises a warming-up bypass line 7 and a warming-up bypass valve 8. The warming-up bypass line 7 is connected opposite in parallel with the first heat source 3a and with the first radiator 4a and can be flowed through in a bypass mode. The warming-up bypass valve 8 can be switched in such a manner that the first radiator 4a can be bypassed via the warming-up bypass line 7. The second partial circuit 2b comprises a radiator bypass line 9 and a radiator bypass valve 10. Basically however the one radiator bypass line 9 can also be omitted. The radiator bypass line 9 is connected opposite in parallel with the second heat source and parallel with the second radiator 4b. Here, the radiator bypass valve 10 can be switched in such a manner that the second radiator 4b can be bypassed via the radiator bypass line 9. If a thermostatic regulation of the temperature of the coolant is not required in the second heat source 3b, the radiator bypass line 9 and the radiator bypass valve 10 can be omitted. By way of this, the cooling system 1 can be simplified.

The two radiators 4a and 4b can be flowed through by air in an airflow direction SR. Then, the first radiator 4a and the second radiator 4b can overlap one another in the airflow direction SR completely or in regions, wherein the first radiator 4a is connected upstream of the second radiator 4b with respect to the airflow direction SR. Behind the second radiator 4b, a blower 11 is additionally arranged, which can promote the flow of air through the second radiator 4b. It is also conceivable that a further blower – not shown here – is arranged behind the second radiator 4b. The two pumps 5a and 5b and the non-return valve 6 can be combined in a common module 14 – as indicated with interrupted lines. Because of this, cost advantages are created and the assembly of the cooling system 1 is simplified. In addition, the module 14 includes five liquid connections which lead to the first heat source 3a, to the second heat source 3b, to the warming-up bypass line 7, to the first radiator 4a and to the second radiator 4b.

FIG. 2 shows a circuit diagram of the cooling system 1 according to the invention in a second embodiment. In the second embodiment, the cooling circuit 2 comprises an advance shut-off valve 12 and a return shut-off valve 13. The advance shut-off valve 12 and the return shut-off valve 13 are connected between the two partial circuits 2a and 2b and can hydraulically separate the two partial circuits 2a and 2b from one another.

Regardless of the embodiment, the cooling system 1 can be operated by means of a method according to the invention in a braking mode, in a normal operating mode and in a warming-up mode.

In the braking mode, the first heat source 3a and the second heat source 3b are switched on and are cooled at the different temperature levels. The pumps 5a and 5b are switched on and the partial circuits 2a and 2b are hydraulically separated from one another. In the first embodiment of the cooling system 1, the pump pressure and the mass flow of the coolant in the two pumps 5a and 5b can be suitably adapted. In the second embodiment, the advance shut-off valve 12 and the return shut-off valve 13 can be closed. Because of this, the first partial circuit 2a is flowed through by a first part of the coolant and the second partial circuit 2b is flowed through by a second part of the coolant. The two parts of the coolant can have different temperatures and because of this, the heat source 3a can be cooled at a lower temperature level and the second heat source 3b at a higher temperature level. Because of this, an overheating of the first heat source 3a can be prevented and the cooling capacity in the second partial circuit 2b increased. The cooling capacity in the second partial circuit 2b can be adapted by means of the radiator bypass valve 10.

In the normal operating mode, the first heat source 3a is switched on and the second heat source 3b switched off. Accordingly, only the first heat source 3a has to be cooled in the normal operating mode. The first partial circuit 2a and the second partial circuit 2b are not hydraulically separated from one another here and are flowed through by a common part of the coolant. To this end, the second pump 5b is switched off in the first embodiment and the second pump 5b switched off in the second embodiment and the advance shut-off valve 2 and the return shut-off valve 13 are open. The first pump 5a by contrast is switched on. Accordingly, the coolant can flow through the first heat source 3a and the first radiator 4a in the normal operating mode. The second radiator 4b can be flowed through or bypassed via the radiator bypass line 9. Here, the flow through the second heat source 3b is prevented by the non-return valve 6 if applicable.

In the warming-up mode, the first heat source 3a is switched on and the second heat source 3b switched off. In the warming-up mode, the second pump 5b is switched off and the warming-up bypass valve 10 switched in such a manner that the second partial circuit 2b and the first radiator 4a are not flowed through. By contrast, the first pump 5a is switched on and delivers a reduced part of the coolant through the first heat source 3a and the warming-up bypass line 7.

1. A cooling system for a vehicle , comprising:
a cooling circuitthat can be flowed through by a coolant,
the cooling circuitcomprises a first heat source coolable at a lower temperature level, a first radiator, a second heat source coolable at a higher temperature level and a second radiator,
a first partial circuitof the cooling circuitis provided with the first heat sourceand the first radiatorfluidically connected to one another and a second partial circuitof the cooling circuitis provided with the second heat sourceand the second radiator fluidically connected to one another,
wherein the first partial circuitand the second partial circuitcan be completely or almost completely hydraulically separated from one another at times such that the first partial circuits and the second partial circuit are flowable through by a part of the coolant, and
wherein the first partial circuitand the second partial circuitcan be completely or almost completely hydraulically connected to one another at times such that the first partial circuits and the second partial circuit are jointly flowable through by a common part of the coolant.

2. The cooling system according to claim 1, wherein:
the cooling circuitcomprises a first pumpand a second pump ,
the first pumpin the first partial circuitand the second pump in the second partial circuitare directly connected downstream or upstream of the first heat sourceand the second heat sourcerespectively, and
the first pumps and the second pump can be regulated such a that the first partial circuits and the second partial circuit can be hydraulically separated from one another completely or almost completely and can be hydraulically connected to one another completely or almost completely.

3. The cooling system according to claim 1, wherein:
the cooling circuit comprises an advance shut-off valveand a return shut-off valve,
the advance shut-off valve and the return shut-off valveare connected between the first partial circuits and the second partial circuit, and
the first partial circuits and the second partial circuit can be hydraulically separated from one another by the advance shut-off valveand the return shut-off valve.

4. The cooling system according to claim 1, wherein at least one of:
the first partial circuitcomprises a warming-up bypass line connected in parallel with the first radiatorfor bypassing the first radiatorand a warming-up bypass valve , wherein the warming-up bypass line is closed and opened via the warming-up bypass valve, and
the second partial circuit comprises a radiator bypass line connected in parallel with the second radiator for bypassing the second radiator and a radiator bypass valve, wherein the radiator bypass line is closed and opened via the radiator bypass valve.

5. The cooling system according to claim 1, further comprising a non-return valve directly connected downstream or upstream of the second heat sourceor of a pumpthat is directly connected downstream or upstream of the second heat source.

6. The cooling system according to claim 1, wherein at least one of:
the first radiator with respect to an airflow direction is connected upstream of the second radiator, and
the first radiator and the second radiator partially or completely overlap one another with respect to an airflow direction.

7. A method for operating a cooling system , comprising:
providing a cooling circuit that is flowed through by a coolant, the cooling circuit including a first heat source coolable at a lower temperature level, a first radiator, a second heat source coolable at a higher temperature level, and a second radiator;
the first heat source and the first radiator being fluidically connected to one another in a first partial circuit of the cooling circuit;
the second heat source and the second radiator being fluidically connected to one another in a second partial circuit of the cooling circuit;
hydraulically separating the first partial circuit and the second partial circuit completely or almost completely from one another at times;
the cooling circuit further including a first pump directly connected upstream or downstream of the first heat source and a second pump directly connected upstream or downstream of the second heat source; and
operating the cooling system in a braking mode, in a normal operating mode and in a warming-up mode.

8. The method according to claim 7, wherein the cooling systemis operated in the braking mode, wherein in the braking mode:
the first pumpand the second pump are switched on;
the first partial circuitand the second partial circuit are hydraulically separated from one another at times completely or almost completely;
the first partial circuit is flowed through by a first part of the coolant and the second partial circuit by a second part of the coolant; and
a temperature of the first part of the coolant in the first partial circuit is lower than a temperature of the second part of the coolant in the second partial circuit.

9. The method according to claim 7, wherein the cooling system is operated in the normal operating mode, wherein in the normal operating mode:
the first pump is switched on and the second pump is switched off;
the first partial circuit and the second partial circuit are hydraulically connected to one another at times completely or almost completely; and
the first partial circuit and at least in regions the second partial circuit are flowed through by a common part of the coolant.

10. The method according to claim 9, wherein in the normal operating mode or in the braking mode the second radiator is flowed through or bypassed via a radiator bypass line.

11. The method according to claim 7, wherein the cooling system is operated in the warming-up mode, wherein in the warming-up mode:
the second pump is switched off;
the second partial circuit and the first radiator are separated from the first heat source via a warming-up bypass valveand are not flowed through;
the first pump is switched on; and
the first heat source and a warming-up bypass line connected in parallel with the first heat source are flowed through.

12. A vehicle, comprising: a cooling system, the cooling system including:
a cooling circuit that is flowed through by a coolant;
the cooling circuit including a first heat source coolable at a lower temperature level, a first radiator, a second heat source coolable at a higher temperature level, and a second radiator;
the first heat source and the first radiator being fluidically connected to one another in a first partial circuit of the cooling circuit;
the second heat source and the second radiator being fluidically connected to one another in a second partial circuit of the cooling circuit;
wherein the first partial circuit and the second partial circuit are completely or almost completely hydraulically separated from one another in a braking mode such that the first partial circuit is flowed through by a first part of the coolant and the second partial circuit is flowered through by a second part of the coolant; and
wherein the first partial circuit and the second partial circuit are completely or almost completely hydraulically connected to one another in a normal operating mode such that the first partial circuit and the second partial circuit are jointly flowed through by a common part of the coolant.

13. The vehicle according to claim 12, wherein the cooling circuit further includes a first pump and a second pump;
the first pump being directly connected downstream or upstream of the first heat source in the first partial circuit, and the second pump being directly connected downstream or upstream of the second heat source in the second partial circuit.

14. The vehicle according to claim 13, wherein in the braking mode the first pump and the second pump are switched on.

15. The vehicle according to claim 13, wherein the normal operating mode the first pump is switched on and the second pump is switched off.

16. The vehicle according to claim 12, wherein the cooling circuit further comprises an advance shut-off valve and a return shut-off valve;
the advance shut-off valve and the return shut-off valve being connected between the first partial circuit and the second partial circuit; and
wherein the first partial circuit and the second partial circuit are hydraulically separated from one another by the advance shut-off valve and the return shut-off valve.

17. The vehicle according to claim 12, wherein the first partial circuit comprises a warming-up bypass line connected in parallel with the first radiator for bypassing the first radiator and a warming-up bypass valve, wherein the warming-up bypass line is closed and opened via the warming-up bypass valve.

18. The vehicle according to claim 12, wherein the second partial circuit comprises a radiator bypass line connected in parallel with the second radiator for bypassing the second radiator and a radiator bypass valve, wherein the radiator bypass line is closed and opened via the radiator bypass valve.

19. The vehicle according to claim 12, wherein the cooling circuit further comprises a non-return valve directly connected downstream or upstream of the second heat source.

20. The cooling system according to claim 4, wherein the warming-up bypass valve comprises a switching valve, a regulating valve, or a thermostat valve.
